(19) United States
(12) Patent Application Publication
(10) Pub. No.: US 2026/0204487 A1
(43) Pub. Date: Jul. 16, 2026

(54) CAPACITOR

(71) Applicant: TDK ELECTRONICS AG, München (DE)

(72) Inventors: Ralf GLÖCKLER, Heidenheim (DE); Florian DECKERT, Aalen (DE); Sebastian WASSERMANN, Welling (DE); Fanni WEIHMÜLLER, Bernstadt (DE)

(21) Appl. No.: 19/136,745

(22) PCT Filed: Dec. 21, 2023
(86) PCT No.: PCT/EP2023/087212

§ 371 Date: Jun. 6, 2025

(30) Foreign Application Priority Data
Jan. 13, 2023 (DE) 10 2023 100 718.1

(51) Int. Cl. H01G 4/40; H01G 2/10; H01G 2/22; H01G 4/232; H01G 4/32; H01G 4/38

(52) U.S. Cl. CPC H01G 4/40; H01G 2/10; H01G 2/22; H01G 4/232; H01G 4/32; H01G 4/38

(57) ABSTRACT

The present invention concerns a capacitor comprising at least four winding elements arranged in a stack, wherein each winding element has a top face and a bottom face, a first busbar and a second busbar, wherein, in a stacking direction of the stack, the first busbar is connected to the top face of the first winding element, to the top face of the last winding element and to the bottom faces of the other winding elements (2-5), and wherein, in the stacking direction of the stack, the second busbar is connected to the bottom face of the first winding element to the bottom face of the last winding element and the top faces of the other winding elements.

### CROSS-REFERENCE TO RELATED APPLICATIONS

This application is a U.S. national stage of International Application No. PCT/EP2023/087212, filed Dec. 21, 2023, which claims the benefit of and priority to German Patent Application No. 10 2023 100 718.1, filed Jan. 13, 2023, each of which are hereby incorporated by reference herein in its entirety.

### FIELD

The present invention concerns a capacitor. In particular, the capacitor may be a metallized DC-link film capacitor. The capacitor may be a power capacitor.

### BACKGROUND

When constructing a DC link capacitor, it is an object to provide a capacitor with a low equivalent series inductance (ESL). WO 2019/101802 A1 propose capacitors, wherein the polarity of each winding element is inverted with respect to the adjacent winding element. Even though this design results in a low ESL, it suffers from the drawbacks of requiring a large amount of copper and of requiring a high number of insulator sheets between the winding elements.

### SUMMARY

It is the object of the present invention to provide an improved capacitor.

This object is solved by the subject-matter of claim 1. The dependent claims concern preferred embodiments of the capacitor.

A capacitor is provided which comprises at least four winding elements arranged in a stack, wherein each winding element has a top face and a bottom face. The top face may be opposite to the bottom face. A winding axis of the winding element may be perpendicular to each of the top face and the bottom face. A winding element may be a capacitance unit. Each winding element of the capacitor may have the same capacitance. Each winding element may have a first pole of a first polarity, e.g. a positive polarity, and a second pole of a second polarity, e.g. a negative polarity. By applying a voltage between the first and the second pole, energy may be stored in the winding element.

The capacitor comprises a first busbar and a second busbar. A busbar may be a metallic stripe, a metallic bar or a metal sheet configured for local high current power distribution.

In a stacking direction of the stack of winding elements, the first busbar is connected to the top face of the first winding element, to the top face of the last winding element and to the bottom faces of the other winding elements. In the stacking direction of the stack of winding elements, the second busbar is connected to the bottom face of the first winding element, to the bottom face of the last winding element and to the top faces of the other winding elements.

Accordingly, the top faces of the outermost winding elements of the stack can be connected to the first busbar and the bottom faces of all other winding elements can also be connected to the first busbar. The bottom faces of the outermost winding elements can be connected to the second busbar and the top faces of the other winding elements can be connected to the second busbar.

This arrangement of the first busbar and the second busbar results in a stack of winding elements, wherein the outermost winding elements have an opposite polarity compared to the other winding elements of the stack. In the stack, in each pair of adjacent winding elements, the adjacent winding elements have an identical polarity, except for the pair formed by the first and the second winding element and for the pair formed by the last and the second to last winding element.

By inverting only the polarities of the outermost winding elements, a magnetic flux of the magnetic fields generated by each of the winding elements in the stack can be compensated sufficiently. This results in a low ESL of the capacitor.

The capacitor is well suited for power applications with voltages above 600 V and switching frequencies of more than 10 kHz. Due to the inversion of the polarities of the outermost winding elements, the magnetic fields generated by each winding element in the stack weaken or even cancel each other. Thus, overall, only a very weak magnetic field may be generated, when a voltage is applied to the winding elements of the stack. This results in a small inductance of the connection of the winding elements and the busbars. Thus, the inductance of the capacitor may be very small. A small inductance between the winding elements is important for a power capacitor as a high inductance would result in resonance effects and high losses due to parasitic inductances and resistances.

Moreover, due to the inversion of the polarities of the outermost winding elements, the inductivities of the overlapping busbars are reduced. Thus, the inductivity of the overall device is reduced.

The term “stack” may refer to a set of winding elements which are arranged next to each other in a stacking direction. The first winding element of the stack may be defined as a winding element which is arranged adjacent to another winding element, i.e., the second winding element, in the stacking direction and which is not arranged to a further winding element in a direction opposite to the stacking direction. The last winding element of the stack may be defined as a winding element which is arranged adjacent to another winding element, i.e., the second-to-last winding element, in the direction opposite to the stacking direction and which is not arranged to a further winding element in the stacking direction. Accordingly, each of the outermost winding elements of the stack may be only adjacent to one winding element of the stack and each of the other winding elements of the stack may be adjacent to two winding elements of the stack.

Preferably, the capacitor does not comprise any other winding elements in addition to the winding elements in the stack.

In some embodiments, the capacitor may comprise multiple stacks of at least winding elements wherein, in each stack, the polarity of the outermost winding elements is inverted compared to the other winding elements. Each of the stacks m comprises a first busbar and a second busbar, wherein, in a stacking direction of the respective stack, the first busbar is connected to the top face of the first winding element, to the top face of the last winding element and to the bottom faces of the other winding elements, and wherein, in the stacking direction of the respective stack, the second busbar is connected to the bottom face of the first winding element, to the bottom face of the last winding element and the top faces of the other winding elements. Preferably, the capacitor does not comprise any other winding elements in addition to the winding elements in the multiple stacks.

As only the outermost winding elements have an inverted polarity compared to the respective adjacent winding elements, only the outermost winding elements need to be isolated against the adjacent winding element, for example by providing an insulator sheet. Compared to a reference capacitor in which each winding element has an opposite polarity to its adjacent winding element, the number of insulators can be reduced significantly. The reduction in the number of insulators results in a reduced weight, in reduced material costs and in a simplified manufacturing process.

The first winding element in the stacking direction of the stack and the last winding element in the stacking direction of the stack have an identical polarity and the other winding elements can have a polarity which is opposite to the polarity of the first winding element.

The first busbar and the second busbar can be arranged such that they overlap each other. In particular, the first busbar and the second busbar can be arranged such that at least 20% of the area of the first busbar is overlapped by the second busbar, preferably at least 50% of the area of the first busbar is overlapped by the second busbar. More preferably, at least 80% of the area of the first busbar is overlapped by the second busbar. In the area of the overlap of the busbars, a thin insulator may be arranged between the busbars, which prevents a short circuit between the busbars.

The first busbar and the second busbar can be configured such that currents in opposite directions flow in the busbars. Due to the overlap of the busbars, a magnetic field generated by the current flowing in the first busbar is compensated or at least weakened by a magnetic field generated by a current flowing in the second busbar. The larger the overlap between the busbars, the better the weakening or cancelling of the magnetic fields. The compensation of the magnetic fields may result in a low inductance and homogenous impedance for all the winding elements. The compensation of the magnetic fields due to the overlapping busbars and the compensation in the magnetic fields due to the inverted polarities of the outermost winding elements in the stack both reduce the parasitic inductance of the capacitor, thereby providing a capacitor with a very low ESL.

The first busbar and the second busbar may be arranged at a lateral face of the stack which is perpendicular to the top faces of the winding elements and perpendicular to the bottom faces of the winding elements. The lateral face of the stack may have a smaller surface than a top face of the stack formed by the top faces of the winding elements and a smaller surface than a bottom face of the stack formed by the bottom faces of the winding elements. By arranging the first busbar and the second busbar on the lateral face of the stack, the busbars are arranged on a face which has a rather small area, thereby only a small amount of material is required for the busbars. The busbars may comprise copper or may consist of copper. By reducing the amount of material for the busbars, the weight and the material costs of the capacitor can be reduced.

A first insulator sheet may separate the first winding element from the other winding elements of the stack, a second insulator sheet may separate the last winding element from the other winding elements of the stack. No insulator sheets may be arranged between the other winding elements of the stack. Further, no resin may be arranged between the winding elements of the stack.

Accordingly, insulator sheets may only be arranged between those pairs of winding elements which have an opposite polarity with respect to each other. Irrespective of the number of winding elements in the stack, only two insulator sheets are required as only the outermost pairs of adjacent winding elements consist of winding elements having opposite polarities with respect to each other. By reducing the number of insulator sheets in the capacitor, the material requirements and the costs for the capacitor can be reduced.

The first busbar may comprise a first part and a second part. The first part may be connected to the top face of the first winding element and the top face of the last winding element. The second part may be connected to the bottom faces of the other winding elements. The two parts of the first busbar may be fixed to each other, for example by laser welding. The second busbar may consist only of a single part.

### BRIEF DESCRIPTION OF THE DRAWINGS

In the following, a preferred embodiment of the present invention is described with respect to the figures.

FIGS. 1 and 2 show a capacitor in a perspective view.

FIG. 3 shows parts of a capacitor.

FIG. 4 shows the results of a simulation of the ESL of the capacitor shown in FIG. 3 and of a reference capacitor.

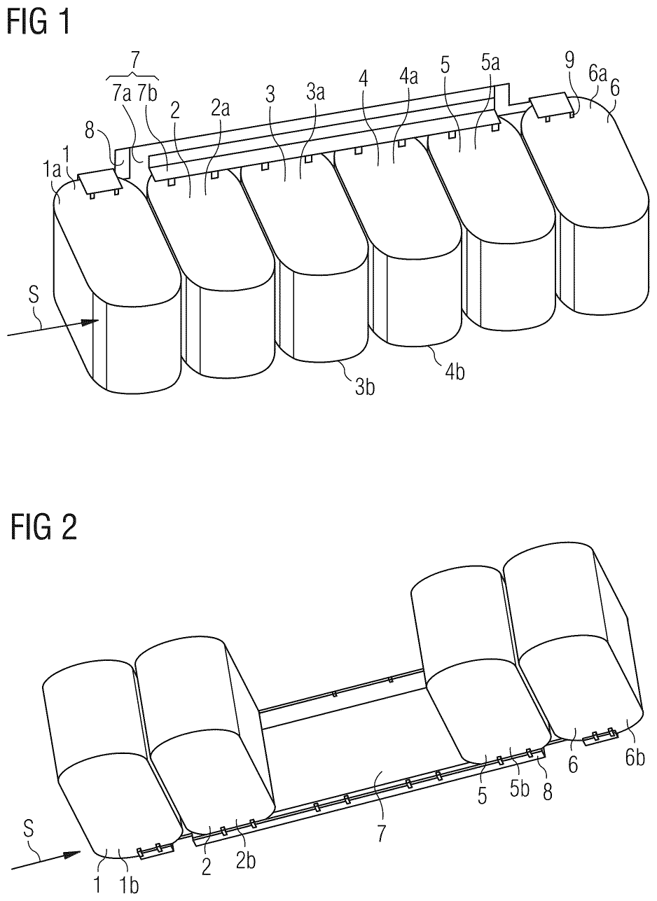

FIGS. 1 and 2 show a capacitor in a perspective view. FIG. 1 shows a view onto a bottom face of the capacitor and FIG. 2 shows a view onto a top face of the capacitor.

The capacitor comprises multiple winding elements 1-6 which are arranged in a stack. Each winding element 1-6 comprises a bottom face 1a-6a and a top face 1b-6b. The top face 1a-6a and the bottom face 1b-6b are opposite to each other and a winding axis of the respective winding element 1-6 is perpendicular to each of the top face 1a-6a and the bottom face 1b-6b.

The winding elements 1-6 are arranged in the stack such that each of the top face 1b-6b faces in the same direction. In particular, a surface normal of each top face 1b-6b is perpendicular to the stacking direction S of the stack. Moreover, the bottom faces 1a-6a of each winding element face in the same direction, wherein the surface normal of the bottom faces 1a-6a are perpendicular to the stacking direction and opposite to the surface normal of the top faces 1a-5a.

In the embodiment shown in FIGS. 1 and 2, the capacitor comprises six winding elements 1-6. For illustration purposes, two of the six winding elements 1-6 are not shown in FIG. 2. The capacitor can also comprise four, five winding elements or any other number of winding elements larger than six.

The capacitor comprises a first busbar 7 and a second busbar 8.

The first busbar 7 and the second busbar 8 are arranged at a lateral face of the stack. The lateral face connects a top face of the stack, which is formed by the top faces 1b-6b of the winding elements 1-6, to a bottom face of the stack, which is formed by the bottom faces 1a-6a of the winding elements 1-6. Each of the first busbar 7 and the second busbar 8 overlaps only a small part of the top face of the stack and the bottom face of the stack. For example, each of the first busbar 7 and the second busbar 8 overlaps less than 10% of the surface of each of the top face of the stack and the bottom face of the stack. This arrangement of the busbars 7, 8 allows to construct busbars 7, 8 with a small surface such that the amount of material used for the busbars 7, 8 remains moderate, thereby providing a low weight of the capacitor.

The first busbar 7 can be connected to a first pole of an external circuit. The second busbar 8 can be connected to a second pole of an external circuit. The first busbar 7 and the second busbar 8 are configured such that currents of opposite polarity flow in the busbars 7, 8.

Each of the first busbar 7 and the second busbar 8 comprises one or more terminals (not shown). The busbars 7, 8 are configured to be connected to an external circuit via their terminals. An electrical signal can be applied to the terminals.

The first busbar 7 is connected to the top face 1b of the first winding element 1 in the stacking direction S. The first busbar 7 comprises two connecting pins 9 which are each connected to the top face 1b of the first winding element 1.

The first busbar 7 is connected to the top face 6b of the last winding element 6 in the stacking direction S. The first busbar 7 comprises two connecting pins 9 which are connected to the top face 6b of the last winding element 6.

The first busbar 7 is connected to the bottom faces 2a-5a of all winding elements 2-5, except for the bottom face 1a of the first winding element 1 and the bottom face 6a of the last winding element 6 in the stacking direction S. The first busbar 7 is connected to each of the bottom faces of the winding elements 2-5 via two connecting pins 9.

The second busbar 8 is connected to the bottom face 1a of the first winding element 1 in the stacking direction S. The second busbar 8 comprises two connecting pins 9 which are each connected to the bottom face 1a of the first winding element 1.

The second busbar 8 is connected to the bottom face 6a of the last winding element 6 in the stacking direction S. The second busbar 8 comprises two connecting pins 9 which are connected to the bottom face 6a of the last winding element 6.

The second busbar 8 is connected to the top faces 2b-5b of all winding elements 2-5, except for the top faces 1b, 6b of the first and the last winding element 1, 6 in the stacking direction S. For each of the winding elements 2-5, except for the first winding element 1 and the last winding element 6 in the stacking direction, the second busbar 8 comprises two connecting elements 9 which are connected to the respective top face 2b-5b.

Accordingly, the first winding element 1 and the last winding element 6 have a polarity which is opposite to the polarity of the other winding elements 2-5. In other words, the outer winding elements 1, 6 of the stack have an opposite polarity compared to the other winding elements 2-5.

The polarities of the winding elements 1-6 alternate along the stacking direction S from the first winding element 1 to the adjacent next winding element 2 and again from the second to last winding element 5 to the last winding element 6. In a middle section of the stack formed between the second winding element 2 and the second to last winding element 5, the polarities of the winding elements 2-5 do not alternate along the stacking direction S.

As a result of the alternation of the polarities of the outermost winding elements 1, 6, the magnetic flux generated by a pair of one of the outermost winding elements 1, 6 and the respective adjacent winding element 2, 5 is compensated. The magnetic flux of other pairs of winding elements in the middle portion of the stack is not compensated. However, the fact that due to the polarity change of the outermost winding elements 1, 6 and the respective adjacent winding element 2, 5, opposing AC currents flow at every point of the busbars 7, 8 and, thus, the inductance within the “supply line” to the winding elements is significantly reduced. The inductance of the individual winding elements 1-6 can already be very low.

With the present parallel connection of winding elements 1-6, this value is divided by the number of winding elements and thus becomes increasingly insignificant.

Overall, this results in only a very small parasitic inductance of the capacitor. By reducing the parasitic inductances, the impedance from the terminals to each winding element 1-6 is more homogenous between the winding elements 1-6 for each frequency in the bandwidth in which the capacitor may be operated. This results in a low and homogenous ESL from each pair of terminals 8.

As discussed above, the first busbar 7 and the second busbar 8 overlap each other. A current flowing through the first busbar 7 generates a first magnetic field and a current flowing through the second busbar 8 generates a second magnetic field. Due to the overlap of the two busbars 7, 8, the first magnetic field and the second magnetic field compensate each other. The compensation of the magnetic fields results in a low inductance and homogenous impedance for all the winding elements 1-6.

The inductance of any magnetic fields appearing from adjacent winding elements 2-5 of the same polarity are compensated for by the reduction of the inductance in the overlapped busbars 7, 8. The combination of overlapped busbars 7, 8 having opposite polarities and a stack wherein the outermost winding elements 1, 6 having an opposite polarity compared to the other winding elements 2-5 result in a very good reduction of the magnetic flux and thereby in a low ESL.

The first busbar 7 consists of a first part 7a and a second part 7b. Each part 7a, 7b is formed by a metal sheet. The first part 7a of the first busbar 7 is connected to the top faces 1b, 6b of the first and the last winding elements 1, 6. The second part 7b of the first busbar 7 is connected to the bottom faces 2b-5b of the other winding elements 2-5. The second part 7b comprises the terminal of the first busbar 7. The first part 7a and the second part 7b are permanently fixed to each other, for example by laser welding.

An insulator is arranged between the first busbar 7 and the second busbar 8 which prevents a short circuit between the two busbars.

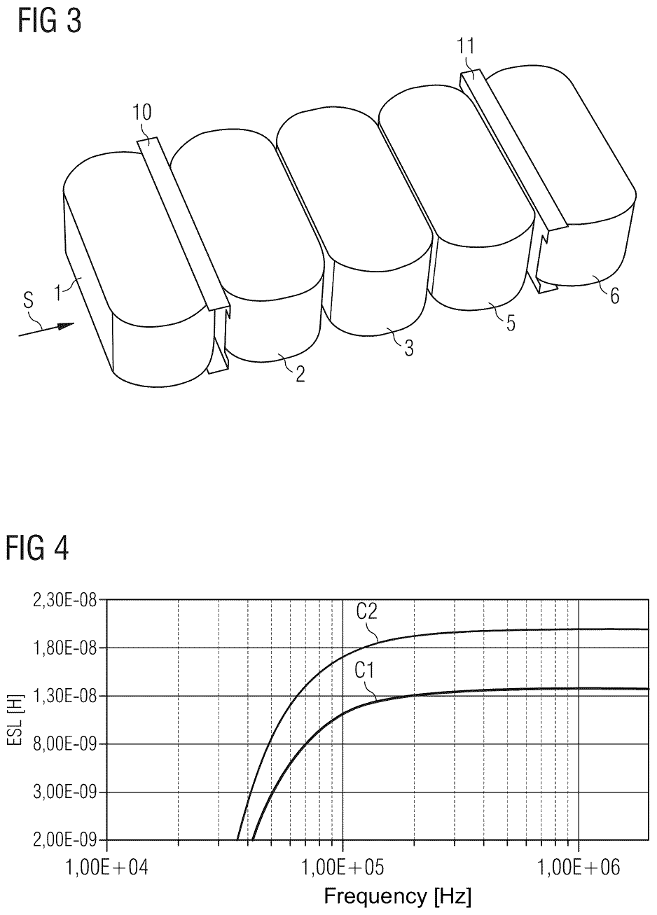

FIG. 3 shows parts of a capacitor which comprises five winding elements 1-3, 5, 6. The capacitor of FIG. 3 differs from the capacitor shown in FIGS. 1 and 2 only in the number of winding elements. For the sake of simplicity, the five winding elements are references as 1-3, 5 and 6 such that the winding element 4 is omitted compared to the capacitor of FIGS. 1 and 2.

In particular, the five winding elements 1-3, 5, 6 of the stack, a first insulator sheet 10 and a second insulator sheet 11 are shown in FIG. 3.

The first insulator sheet 10 is arranged between the first winding element 1 and the second winding element 2 in the stacking direction S. The second insulator sheet 11 is arranged between the last winding element 6 and the second to last winding element 5 in the stacking direction S.

Accordingly, the insulator sheets 10, 11 are arranged between each pair of winding elements 1-2, 5-6 having an opposite polarity. The insulator sheets 10, 11 are not arranged between winding elements 1-3, 5 of the same polarity. Compared to a capacitor, wherein each winding element has an opposite polarity compared to its adjacent winding element, the number of insulator sheets can be reduced, thereby reducing the weight and the costs for the capacitor. The design of the capacitors as shown in FIGS. 1 to 3 requires only two insulator sheets 10, 11 for any stack of winding elements, whereas in a capacitor having n winding elements with opposite polarities between each pair of adjacent winding elements, n−1 insulator sheets are required for a stack of n winding elements. In the capacitors shown in FIGS. 1 to 3, the number of insulator sheets is always two for any number if n winding elements in the stack.

FIG. 4 shows the results of a simulation of the ESL of the capacitor shown in FIG. 3 and of a reference capacitor. The first curve C1 shows the ESL for a pair of terminals of a capacitor as shown in FIG. 3. The second curve C2 shows the ESL of a pair of terminals of a reference capacitor wherein all winding elements have the same polarity. Compared to the reference capacitor, the ESL is reduced by roughly 6 nH. Thus, altering the polarities of the outermost winding elements 1, 5 significantly reduces the ESL and, at the same time, only results in a moderate increase in the weight and the cost as only two additional insulator sheets 10, 11 are required. These insulator sheets 10, 11 are arranged between each pair of winding elements 1-2, 5-6 having an opposite polarity.

### REFERENCE NUMBERS

1 winding element
1a bottom face
1b top face
2 winding element
2a bottom face
2b top face
3 winding element
3a bottom face
3b top face
4 winding element
4a bottom face
4b top face
5 winding element
5a bottom face
5b top face
6 winding element
6a bottom face
6b top face
7 first busbar
7a first part
7b second part
8 second busbar
9 connecting pin
10 first insulator sheet
11 second insulator sheet
S stacking direction

1-10. (canceled)

11. A capacitor comprising:
a first busbar;
a second busbar; and
a plurality of winding elements arranged in a stack, the plurality of winding elements including a first winding element, two or more middle winding elements, and a last winding element, the two or more middle winding elements being positioned between the first winding element and the last winding element in the stack, each of the plurality of winding elements having a top face and a bottom face, wherein, in a stacking direction of the stack, the first busbar is connected to the top face of the first winding element, to the top face of the last winding element, and to the bottom face of each of the two or more middle winding elements, and wherein, in the stacking direction of the stack, the second busbar is connected to the bottom face of the first winding element, to the bottom face of the last winding element, and to the top face of each of the two or more middle winding elements.

12. The capacitor of claim 11, wherein the stacking direction of the stack is perpendicular to a surface normal to the top face of each of the plurality of winding elements.

13. The capacitor of claim 11, wherein the first winding element and the last winding element have an identical polarity, and wherein each of the two or more middle winding elements has a polarity opposite to the polarity of the first winding element.

14. The capacitor of claim 11, wherein the first busbar and the second busbar are arranged to overlap each other.

15. The capacitor of claim 14, wherein the first busbar and the second busbar are arranged such that at least 20% of an area of the first busbar is overlapped by the second busbar.

16. The capacitor of claim 14, wherein the first busbar and the second busbar are arranged such that at least 50% of an area of the first busbar is overlapped by the second busbar.

17. The capacitor of claim 11, wherein the first busbar and the second busbar are arranged at a lateral face of the stack, the lateral face being perpendicular to both the top face and the bottom face of each of the plurality of winding elements.

18. The capacitor of claim 11, wherein a first insulator sheet separates the first winding element from an adjacent one of the two or more middle winding elements of the stack, wherein a second isolator sheet separates the last winding element from an adjacent one of the two or more middle winding elements of the stack, and wherein no isolator sheets are arranged between any two adjacent ones of the two or more middle winding elements.

19. The capacitor of claim 11, wherein the first busbar further comprises a first part and a second part, the first part being connected to the top face of the first winding element and to the top face of the last winding element in the stacking direction, and the second part being connected to the bottom face of each of the two or more middle winding elements.

20. The capacitor of claim 19, wherein the first part and the second part of the first busbar are fixed together.

21. The capacitor of claim 11, wherein the second busbar includes a single part.

22. A capacitor comprising:
a first busbar;
a second busbar, the second busbar and the first busbar being arranged to overlap each other; and
a plurality of winding elements arranged in a stack, the plurality of winding elements including a first winding element, two or more middle winding elements, and a last winding element, the two or more middle winding elements being positioned between the first winding element and the last winding element in the stack, each of the plurality of winding elements having a top face and a bottom face, wherein, in a stacking direction of the stack, the first busbar is connected to the top face of the first winding element, to the top face of the last winding element, and to the bottom face of each of the two or more middle winding elements, and wherein, in the stacking direction of the stack, the second busbar is connected to the bottom face of the first winding element, to the bottom face of the last winding element, and to the top face of each of the two or more middle winding elements.

23. The capacitor of claim 22, wherein the stacking direction of the stack is perpendicular to a surface normal to the top face of each of the plurality of winding elements.

24. The capacitor of claim 22, wherein the first busbar and the second busbar are arranged such that at least 20% of an area of the first busbar is overlapped by the second busbar.

25. The capacitor of claim 22, wherein the first busbar and the second busbar are arranged such that at least 50% of an area of the first busbar is overlapped by the second busbar.

26. The capacitor of claim 22, wherein the first busbar and the second busbar are arranged at a lateral face of the stack, the lateral face being perpendicular to both the top face and the bottom face of each of the plurality of winding elements.

27. A capacitor comprising:
a first busbar;
a second busbar;
a plurality of winding elements arranged in a stack, the plurality of winding elements including a first winding element, two or more middle winding elements, and a last winding element, the two or more middle winding elements being positioned between the first winding element and the last winding element in the stack, each of the plurality of winding elements having a top face and a bottom face, wherein, in a stacking direction of the stack, the first busbar is connected to the top face of the first winding element, to the top face of the last winding element, and to the bottom face of each of the two or more middle winding elements, and wherein, in the stacking direction of the stack, the second busbar is connected to the bottom face of the first winding element, to the bottom face of the last winding element, and to the top face of each of the two or more middle winding elements;
a first insulator sheet separating the first winding element from an adjacent one of the two or more middle winding elements of the stack; and
a second isolator sheet separating the last winding element from an adjacent one of the two or more middle winding elements of the stack, and no isolator sheets being arranged between any two adjacent ones of the two or more middle winding elements.

28. The capacitor of claim 27, wherein the first busbar further comprises a first part and a second part, the first part being connected to the top face of the first winding element and to the top face of the last winding element in the stacking direction, and the second part being connected to the bottom face of each of the two or more middle winding elements.

29. The capacitor of claim 28, wherein the first part and the second part of the first busbar are fixed together.

30. The capacitor of claim 27, wherein the second busbar includes a single part.
